(19) United States
(12) Patent Application Publication
(10) Pub. No.: US 2007/0215117 A1
(43) Pub. Date: Sep. 20, 2007

(54) Electromagnetic Fuel Injection Valve

(76) Inventors: Daisuke Matsuo, Miyagi (JP); Kazuhiko Sato, Miyagi (JP); Tomoyuki Ohmura, Miyagi (JP); Kenichi Sato, Miyagi (JP); Osamu Hinata, Miyagi (JP)

Correspondence Address: ARENT FOX PLLC, 1050 CONNECTICUT AVENUE, N.W., SUITE 400, WASHINGTON, DC, 20036, US

(21) Appl. No.: 10/589,500

(22) PCT Filed: Feb. 25, 2005
(86) PCT No.: PCT/JP05/03126

§ 371 Date: May 24, 2007

(30) Foreign Application Priority Data
Feb. 27, 2004 (JP) 2004-053691
Mar. 9, 2004 (JP) 2004-065984
Mar. 9, 2004 (JP) 2004-065985

(51) Int. Cl. F02M 51/00

(52) U.S. Cl. 123/476

(57) ABSTRACT

In an electromagnetic fuel injection valve including a resin molded part of a synthetic resin which integrally has a coupler to which a connecting terminal connecting to a coil of a coil assembly is faced, and in which at least part of the solenoid housing is embedded, the resin molded part (7) is formed by a first resin molded layer (7a) which is formed of a synthetic resin with mixture of glass fibers to cover at least part of the solenoid housing (25) and form at least part of a coupler (40), and a second resin molded layer (7b) which is formed of thermoplastic polyester elastomer with mixture of glass fibers excluded to cover the first resin molded layer (7a). This makes it possible to effectively suppress occurrence of operation sound while securing sufficient strength for obtaining reliability of an electrical connecting portion and to make the fuel injection valve compact.

### TECHNICAL FIELD

The present invention relates to an electromagnetic fuel injection valve, and particularly related to an electromagnetic fuel injection valve including a valve operating part in which a valve body spring-biased in a direction to be seated in a valve seat is accommodated in a valve housing having the valve seat at a front end, a solenoid part in which a coil assembly capable of exhibiting an electromagnetic force which drives the valve body to the side to be separated from the valve seat is accommodated in a solenoid housing provided to connect to the valve housing, and a resin molded part of a synthetic resin which integrally has a power receiving coupler to which a connecting terminal connecting to the coil of the coil assembly is faced, at least part of the solenoid housing being embedded in the resin molded part.

### BACKGROUND ART

In such an electromagnetic fuel injection valve, the one in which the entire fuel injection valve is covered with a rubber noise-proof cover to suppress occurrence of operation sound (see Patent Document 1), and the one in which a vibration isolator which covers a part of the solenoid housing is further covered with a resin molded part having a power receiving coupler (see Patent Document 2) are already known.

Patent Document 1:

Japanese Patent Application Laid-open No. 62-195452

Patent Document 2:

Japanese Patent Application Laid-open No. 63-41658

### DISCLOSURE OF THE INVENTION

### Problems to be Solved by the Invention

As disclosed in the above-described Patent Document 1, the electromagnetic fuel injection valve of which entire fuel injection valve is covered with the noise-proof cover results in increase in size of the entire fuel injection valve, and is difficult to be applied in the case where the disposition space of the electromagnetic fuel injection vale is limited in a motorcycle and the like. In the one disclosed in the above-described Patent Document 2, which has the two-layer structure of the vibration isolator and the resin molded part, the power receiving coupler needs to be made relatively high in strength to enhance reliability of the electrical connection part and the resin molded part is generally formed of the synthetic resin including glass fibers. The glass fibers in the resin molded part easily transmits sound, and though a part of the solenoid housing is covered with the two-layer structure of the vibration isolator and the resin molded part, the effect of suppressing the operation sound is low.

The present invention has been achieved in view of the above-mentioned circumstances, and has an object to provide an electromagnetic fuel injection valve which effectively suppresses occurrence of operation sound while securing sufficient strength for obtaining reliability of an electrical connection part, and is capable of being made compact.

### MEANS FOR SOLVING THE PROBLEMS

In order to achieve the object, according to a first feature of the present invention, there is provided an electromagnetic fuel injection valve, comprising a valve operating part in which a valve body spring-biased in a direction to be seated in a valve seat is accommodated in a valve housing having the valve seat at a front end thereof, a solenoid part in which a coil assembly capable of exhibiting electromagnetic force for driving the valve body to a side to separate from the valve seat is accommodated in a solenoid housing provided to connect to the valve housing, and a resin molded part of a synthetic resin which integrally has a power receiving coupler to which a connecting terminal connecting to a coil of the coil assembly is faced, at least part of the solenoid housing being embedded in the resin molded part, characterized in that the resin molded part comprises a first resin molded layer which is formed of a synthetic resin with mixture of glass fibers to cover at least part of the solenoid housing and form at least part of the power receiving coupler, and a second resin molded layer which is formed of thermoplastic polyester elastomer with mixture of glass fibers excluded to cover the first resin molded layer.

According to a second feature of the present invention, in addition to the first feature, the first resin molded layer is formed of liquid polymer with mixture of glass fibers.

According to a third feature of the present invention, there is provided an electromagnetic fuel injection valve, comprising a valve operating part in which a valve body spring-biased in a direction to be seated in a valve seat is accommodated in a valve housing having the valve seat at a front end thereof, a solenoid part in which a coil assembly capable of exhibiting electromagnetic force for driving the valve body to a side to separate from the valve seat is accommodated in a solenoid housing provided to connect to the valve housing, and a resin molded part of a synthetic resin which integrally has a power receiving coupler to which a power receiving side connecting terminal connecting to a coil of the coil assembly is faced, at least part of the solenoid housing being embedded in the resin molded part, characterized in that the resin molded part is formed by two-layer molding of a first resin molded layer which covers at least part of the solenoid housing and forms a coupler main part forming a skeletal structure of the power receiving coupler, and a second resin molded layer which is formed of a material with smaller bending strength than the first resin molded layer and covers the first resin molded layer so that the first resin molded layer is exposed at a tip end side from an intermediate portion of the power receiving coupler, and at least one engaging groove endlessly continuing in which the second resin molded layer is engaged is formed at the first resin molded layer at the intermediate portion of the power receiving coupler.

According to a fourth feature of the present invention, in addition to the third feature, a projected portion which elastically contacts a power supplying coupler attachably and detachably connected to the power receiving coupler is formed at the second resin molded layer at the portion forming part of the power receiving coupler, and an engaging projection which detachably engages with the power supplying coupler is formed at the first resin molded layer at the portion forming part of the power receiving coupler to sandwich the engaging groove between the engaging projection and the projected portion.

According to a fifth feature of the present invention, in addition to the third or the fourth feature, the first resin molded layer is formed of liquid crystal polymer with mixture of glass fibers.

According to a sixth feature of the present invention, in addition to the third or the fourth feature, the second resin molded layer is formed of thermoplastic polyester elastomer with mixture of glass fibers excluded.

According to a seventh feature of the present invention, there is provided an electromagnetic fuel injection valve, comprising a valve operating part in which a valve body spring-biased in a direction to be seated in a valve seat is accommodated in a valve housing having the valve seat at a front end thereof, a solenoid part in which a coil assembly capable of exhibiting electromagnetic force for driving the valve body to a side to separate from the valve seat is accommodated in a solenoid housing provided to connect to the valve housing, and a resin molded part of a synthetic resin which integrally has a power receiving coupler to which a power receiving side connecting terminal connecting to a coil of the coil assembly is faced, at least part of the solenoid housing being embedded in the resin molded part, characterized in that the resin molded part is formed by two-layer molding of a first resin molded layer which covers at least part of the solenoid housing and forms part of the power receiving coupler, and a second resin molded layer which is formed of a material with larger linear expansion coefficient than the first resin molded layer and covers the first resin molded layer, and an air layer is partially formed between the first and the second resin molded layers.

According to an eighth feature of the present invention, in addition to the seventh feature, the second resin molded layer comprises a thick-walled portion at the center part thereof, and a thin-walled portion at a tail end side which connect to the thick-walled portion as a thinner portion than the thick-walled portion, and the thin-walled portion interlocks with the first resin molded layer or a metal member via concavo-convex engagement.

According to a ninth feature of the present invention, in addition to the eighth feature, an outer surface of the first resin molded layer is formed to be a rougher surface than the other parts, in a vicinity of the concavo-convex engagement portions with the thin-walled portion.

According to a tenth feature of the present invention, in addition to any one of the seventh to ninth features, the first resin molded layer is formed of liquid crystal polymer with mixture of glass fibers.

According to an eleventh feature of the present invention, in addition to any one of the seventh to ninth features, the second resin molded layer is formed of thermoplastic polyester elastomer with mixture of glass fibers excluded.

### EFFECT OF THE INVENTION

With the first feature, the resin molded part has the two-layer structure formed of the first resin molded layer and the second resin molded layer, and the first resin molded layer is formed of the synthetic resin with mixture of glass fibers. Therefore, the connection part of the coil of the coil assembly and the connecting terminal can be covered with the first resin molded layer, and at least part of the power receiving coupler is formed by the first rein molded layer, whereby strength with which reliability of the electrical connection part can be secured can be given to the resin molded part. In addition, the second resin molded layer covering the first resin molded layer is formed of thermoplastic polyester elastomer with mixture of glass fibers excluded, and therefore, it is possible to effectively suppress occurrence of the operation sound by excellent flexibility of thermoplastic polyester elastomer. In addition, as compared with the fuel injection valve of which entire body is covered with the noise-proof cover, the entire electromagnetic fuel injection valve can be made compact.

With the second feature, the liquid crystal polymer has the function of relatively suppressing transmission of operation sound, and has high rigidity, and therefore, strength for securing reliability of the electrical connection part can be more enhanced, thus making it possible to suppress occurrence of operation sound more effectively.

With the third feature, the resin molded part has the two-layer structure formed of the first resin molded layer and the second resin molded layer, and the first resin molded layer is formed of the synthetic resin with relatively high bending strength. Therefore, the connection part of the coil of the coil assembly and the power receiving side connecting terminal can be covered with the first resin molded layer, and the coupler main part forming the skeletal structure of the power receiving coupler is formed by the first rein molded layer, whereby the strength with which reliability of the electrical connection part can be secured can be given to the resin molded part. In addition, the second resin molded layer covering the first resin molded layer is formed of synthetic resin with relatively low bending strength, and therefore, it is possible to effectively suppress occurrence of the operation sound, and as compared with the fuel injection valve of which entire body is covered with the noise-proof cover, the entire electromagnetic fuel injection valve can be made compact. In addition, the portion up to the intermediate portion of the power receiving coupler is molded to be two-layer, whereby occurrence of the operation sound from the power receiving coupler can be effectively reduced by the second resin molded layer while the strength required of the power receiving coupler is obtained from the first resin molded layer. Since the second resin molded layer engages in the engaging groove of the first resin molded layer at the intermediate portion of the power receiving coupler, shrinkage of the second resin molded layer after completion of two-layer molding is suppressed, and adhesion of the two layers is enhanced, whereby the product quality can be improved.

With the fourth feature, the projected portion formed at the second resin molded layer with relatively low bending strength is made to elastically contact the power supplying coupler, whereby it is possible to enhance vibration resistance and reduce resonance, and the engaging projection with which the power supplying coupler is engaged is formed at the first resin molded layer with relatively high bending strength, whereby sufficient durability against repetition of attachment and detachment of the power supplying coupler can be secured.

With the fifth feature, the liquid crystal polymer with mixture of glass fibers has the function of relatively suppressing transmission of the operation sound, and has high rigidity. Therefore, strength for securing reliability of the electrical connection part can be more enhanced, and it is possible to suppress occurrence of the operation sound more effectively.

With the sixth feature, thermoplastic polyester elastomer with mixture of glass fibers excluded has excellent elasticity, and thus, it is possible to effectively suppress occurrence of operation sound.

With the seventh feature, the resin molded part has the two-layer structure formed of the first resin molded layer and the second resin molded layer, and the first resin molded layer is formed of the synthetic resin with relatively small linear expansion coefficient. Therefore, the connection part of the coil of the coil assembly and the power receiving side connecting terminal can be covered with the first resin molded layer, and at least part of the power receiving coupler is formed by the first rein molded layer, whereby the strength with which reliability of the electrical connection part can be secured can be given to the resin molded part. In addition, the second resin molded layer covering the first resin molded layer is formed of flexible synthetic resin with relatively large linear expansion coefficient. Therefore, it is possible to effectively suppress occurrence of the operation sound by flexibility of the second resin molded layer, and the air layer is partially formed between the first and second resin molded layers, thus making it possible to further suppress transmission of the operation sound. In addition, as compared with the fuel injection valve of which entire body is covered with the noise-proof cover, the entire electromagnetic fuel injection valve can be made compact.

With the eighth feature, by changing the wall thickness of the second resin molded layer in accordance with regions, the shrinkage amount at the time of cooling immediately after molding is partially changed, and the air layer can be automatically formed at the peripheral portion of the thick-walled portion. Namely, at the thin-walled portion at the tail end side, the cooling speed is relatively high, and by projection-and-recession engagement, adhesion to the first resin molded layer or metal member is enhanced, therefore making it possible to reduce the shrinkage amount. In the thick-walled portion at the center part, the cooling speed is relatively slow, and the shrinkage amount becomes relatively large, thus making it possible to form the air layer by making the center part of the second resin molded layer shrink to a relatively large extent by gradually cooling the center part, while suppressing shrinkage at the tail end side of the second resin molded layer by the projection-and-recession engagement.

With the ninth feature, adhesion of the second resin molded layer at the tail end side to the first resin molded layer can be enhanced, and quality can be enhanced by suppressing shrinkage of the second resin molded layer after two-layer molding.

With the tenth feature, the liquid crystal polymer has the function of relatively suppressing transmission of the operation sound, and has high rigidity, thus making it possible to enhance strength for securing reliability of the electrical connection part and suppress occurrence of the operation sound more effectively.

With the eleventh feature, the thermoplastic polyester elastomer with mixture of glass fibers excluded has excellent elasticity, and makes it possible to effectively suppress occurrence of operation sound.

### BRIEF DESCRIPTION OF THE DRAWINGS

FIG. 1 is a longitudinal sectional view of an electromagnetic fuel injection valve of a first embodiment (first embodiment).

FIG. 2 is a graph showing the relationship between bending strength and operation sound pressure peak of liquid crystal polymer with mixture of glass fibers and thermoplastic polyester elastomer (first embodiment).

FIG. 3 is a sectional view taken along the line 3-3 in FIG. 1 (first embodiment).

FIG. 4 is a longitudinal sectional view of an electromagnetic fuel injection valve of a second embodiment (second embodiment).

FIG. 5 is a longitudinal sectional view of an electromagnetic fuel injection valve of a third embodiment (third embodiment).

FIG. 6 is a longitudinal sectional view of an electromagnetic fuel injection valve (fourth embodiment).

FIG. 7 is a graph showing the relationship between linear expansion coefficient and operation sound pressure peak of liquid crystal polymer with mixture of glass fibers and thermoplastic polyester elastomer (fourth embodiment).

### DESCRIPTION OF THE REFERENCE NUMERALS AND CHARACTERS

5 . . . valve operating part
6 . . . solenoid part
7, 37 . . . resin molded part
7a, 37a . . . first resin molded layer
7b, 37b . . . second resin molded layer
8 . . . valve housing
13 . . . valve seat
20 . . . valve body
24 . . . coil assembly
25 . . . solenoid housing
30 . . . coil
37ba . . . thick-walled portion
37bb, 37bc, 37bd . . . thin-walled portion
38 . . . power receiving side connecting terminal
40 . . . power receiving coupler
40a . . . coupler main part
41, 57, 58 engaging groove
44 . . . air layer
46 . . . power supplying coupler
51 . . . projected portion
55 . . . engaging projection

### BEST MODE FOR CARRYING OUT THE INVENTION

Hereinafter, a mode for carrying out the present invention will be explained based on embodiments of the present invention shown in the attached drawings.

### Embodiment 1

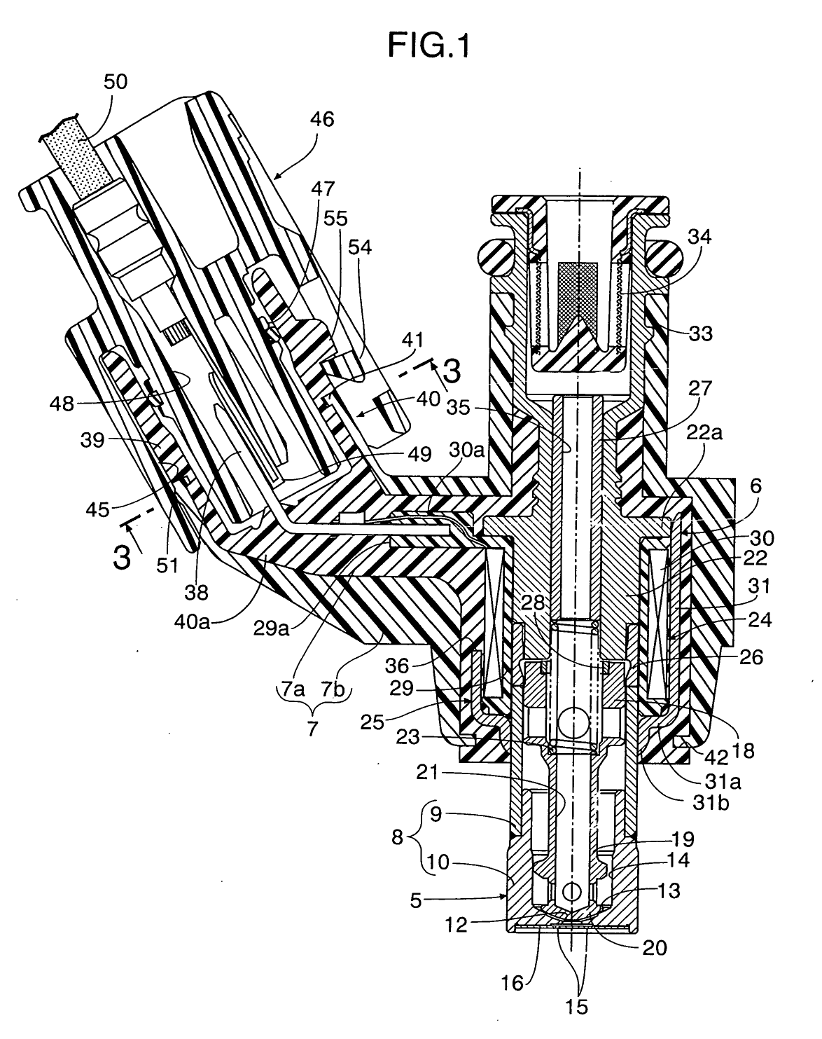

FIGS. 1 to 3 show a first embodiment of the present invention.

First, in FIG. 1, an electromagnetic fuel injection valve for injecting fuel to an engine not shown includes a valve operating part 5 in which a valve body 20 which is biased in a direction to seat on a valve seat 13 is accommodated in a valve housing 8 having the valve seat 13 at a front end, a solenoid part 6 in which a coil assembly 24 capable of exhibiting electromagnetic force for driving the valve body 20 to a side to be separated from the valve seat 13 is accommodated in a solenoid housing 25 provided to connect to the valve housing 8, and a resin molded part 7 of a synthetic resin which integrally has a power receiving coupler 40 to which power receiving side connecting terminals 38 connecting to a coil 30 of the coil assembly 24 are faced, and in which at least the coil assembly 24 and the solenoid housing 25 are embedded.

The valve housing 8 is formed by a magnetic cylinder body 9 formed of magnetic metal, and a valve seat member 10 connected to a front end of the magnetic cylinder body 9 to be liquid-tight. The valve seat member 10 is welded to the magnetic cylinder body 9 with its rear end portion fitted in a front end portion of the magnetic cylinder body 9, and this valve seat member 10 is coaxially provided with a fuel outlet port 12 opened to its front end surface, a tapered valve seat 13 connecting to an inner end of the fuel outlet port 12, and a guide hole 14 connecting to a rear end large diameter portion of the valve seat 13. An injector plate 16 of steel having a plurality of fuel injection holes 15 communicating with the fuel outlet port 12 is welded all around to a front end of the valve seat member 10 to be liquid-tight.

A movable core 18 forming a part of the solenoid part 6 is slidably fitted in a rear portion in the valve housing 8, the valve body 20 capable of closing the fuel outlet port 12 by sitting on the valve seat 13 is integrally formed at a front end of a valve shaft 19 integrally connected to the movable core 18. A through-hole 21 communicating with the valve housing 8 is formed into a bottomed shape with a front end being closed in the movable core 18, the valve shaft 19 and the valve body 20 to be coaxial with each other.

The solenoid part 6 includes the movable core 18, a cylindrical fixed core 22 opposed to the movable core 18, a return spring 23 which exhibits spring force for biasing the movable core 18 to a side to separate the movable core 18 from the fixed core 22, the coil assembly 24 disposed to be capable of exhibiting magnetic force for attracting the movable core 18 to the fixed core 22 side against the spring force of the return spring 23 and surround the rear portion of the valve housing 8 and the fixed core 22, and a solenoid housing 25 which surrounds the coil assembly 24 so that a front end portion of the solenoid housing 25 is connected to the valve housing 8.

A rear end of the magnetic cylinder body 9 in the valve housing 8 is coaxially connected to a front end of the fixed core 22 via a nonmagnetic cylinder body 26 formed of nonmagnetic metal such as stainless steel, the rear end of the magnetic cylinder body 9 is butt-welded to a front end of the nonmagnetic cylinder body 26, and the rear end of the nonmagnetic cylinder body 26 is welded to the fixed core 22 with a front end portion of the fixed core 22 fitted in the nonmagnetic cylinder body 26.

A cylindrical retainer 27 is fitted into the fixed core 22 and fixed by crimping, and the return spring 23 is interposed between the retainer 27 and the movable core 18. A ring-shaped stopper 28 made of a nonmagnetic material is fitted in and fixed to an inner circumference of a rear end portion of the movable core 18 to be slightly projected to the fixed core 22 side from a rear end surface of the movable core 18 in order to avoid direct contact of the movable core 18 with the fixed core 22. The coil assembly 24 is formed by winding the coil 30 around a bobbin 29 which surrounds the rear portion of the valve housing 8, the nonmagnetic cylinder body 26 and the fixed core 22.

The solenoid housing 25 is formed by a magnetic frame 31, which is cylindrical and formed of magnetic metal, has an annular end wall 31a opposed to an end portion of the coil assembly 24 at the valve operating part 5 side and surrounds the coil assembly 24, and a flange portion 22a which is protruded outward in a radius direction from the rear end portion of the fixed core 22 and opposed to an end portion of the coil assembly 24 at the opposite side from the valve operating part 5, and the flange portion 22a is magnetically coupled to the other end portion of the magnetic frame 31. In addition, a fitting cylindrical portion 31b in which the magnetic cylindrical body 9 in the valve housing 8 is fitted is coaxially provided at an inner circumference of the end wall 31a in the magnetic frame 31, and the solenoid housing 25 is provided to connect to the valve housing 8 by fitting the valve housing 8 into the fitting cylindrical portion 31b.

A cylindrical inlet cylinder 33 is integrally and coaxially connected to the rear end of the fixed core 22, and a fuel filter 34 is fitted in the rear portion of the inlet cylinder 33. In addition, the inlet cylinder 33, the retainer 27 and the fixed core 22 are coaxially provided with a fuel passage 35 communicating with the through-hole 21 of the movable core 18.

The resin molded part 7 is formed to bury and seal not only the solenoid housing 25 and the coil assembly 24 but also a part of the valve housing 8 and most part of the inlet cylinder 33 while filling a gap between the solenoid housing 25 and the coil assembly 24. The magnetic frame 31 of the solenoid housing 25 is provided with a notched portion 36 for allowing an arm portion 29a integrally formed at the bobbin 29 of the coil assembly 24 to be disposed outside the solenoid housing 25.

The rein molded part 7 is integrally provided with the power receiving coupler 40 having a cylinder wall 39 to which the power receiving side connecting terminals 38 connecting to opposite ends of the coil 30 in the coil assembly 24 are faced, and base ends of the power receiving connecting terminals 38 are embedded in the arm portion 29a, and coil ends 30a of the coil 30 are welded to the power receiving side connecting terminals 38.

Incidentally, the resin molded part 7 is formed by two-layer molding of a first resin molded layer 7a which covers at least part of the solenoid housing 25 and forms a coupler main part 40a forming a skeletal structure of the power receiving coupler 40, and a second resin molded layer 7b which covers the first resin molded layer 7a so that the first resin molded layer 7a is exposed at a tip end side from an intermediate portion of the power receiving coupler 40. In this embodiment, all parts of the solenoid housing 25, the rear part of the valve housing 8 and a part of the inlet cylinder 33 are covered with the first resin molded layer 7a, and the coupler main part 40a of the power receiving coupler 40 is formed of the first resin molded layer 7a.

While the first resin molded layer 7a is formed of a material with relatively large bending strength, the second resin molded layer 7b is formed of a material with smaller bending strength than the first resin molded layer 7a. The first resin molded layer 7a is formed of liquid crystal polymer in which glass fibers are mixed, and the second resin molded layer 7b is formed of thermoplastic polyester elastomer with mixture of glass fibers excluded, for example, Hytrel, trade name (E. I DuPont de Nemours & Company (Inc.), U.S.A.).

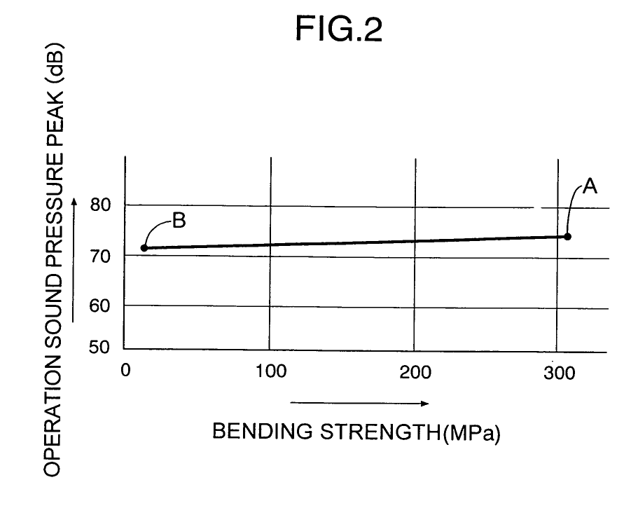

The relationship of the bending strength and the operation sound pressure peak occurring from the resin molded part 7 in the case where the entire resin molded part 7 is molded of liquid polymer including, for example, 35% of glass fibers is as shown by the point A in FIG. 2, and the liquid crystal polymer has the function of relatively suppressing transmission of the operation sound and has high rigidity. On the other hand, when the entire resin molded part 7 is formed of thermoplastic polyester elastomer with exclusion of mixture of glass fibers, occurrence of the operation sound can be suppressed by excellent flexibility of thermoplastic polyester elastomer, and as shown by the point B in FIG. 2, the operation sound pressure peak can be suppressed to be low though the bending strength becomes lower as compared with liquid crystal polymer.

Incidentally, at the tip end side from the intermediate part of the power receiving coupler 40, the first resin molded layer 7a is exposed to the outside without being covered with the second resin molded layer 7b, and at the portion corresponding to the rear part of the valve housing 8, a part of the first resin molded layer 7a is exposed to the outside without being covered with the second resin molded layer 7b. At least one engaging groove in which the second resin molded layer 7b is engaged, in this embodiment, one of engaging grooves 41 and 42 which endlessly continue is formed at the first rein molded layer 7a to have, for example, substantially U-shaped cross sectional shape, at each border portion of the first and the second resin molded layers 7a and 7b at the portions corresponding to the intermediate portion of the power receiving coupler 40 and the rear portion of the valve housing 8.

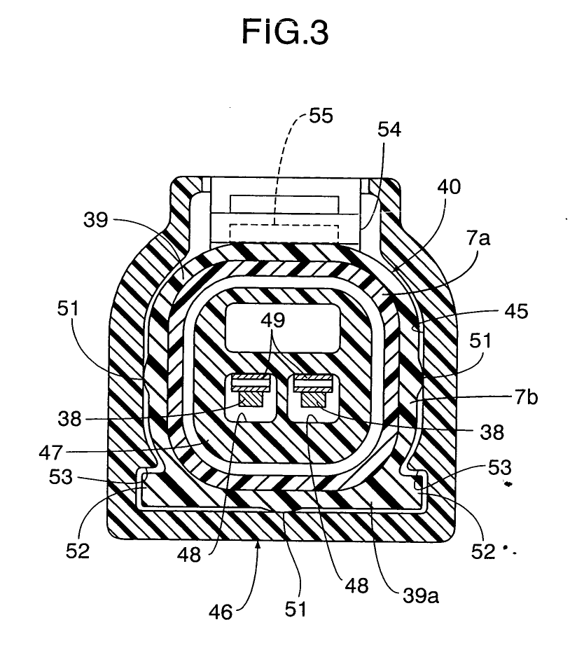

Referring also to FIG. 3, it is possible to attachably and detachably connect a power supplying coupler 46 of a synthetic resin having a recessed part 45, in which the cylinder wall 39 is inserted, to the power receiving coupler 40. This power supplying coupler 46 has an insertion portion 47 capable of being inserted into the cylinder wall 39 of the power receiving coupler 40, and power supplying side connecting terminals 49 which are made electrically connectable to the power receiving side connecting terminals 38 are respectively placed in a pair of connecting holes 48 which are provided at the insertion portion 47 so that the power receiving side connecting terminals 38 are inserted therein, and a lead wire 50 connecting to the power supplying side connecting terminals 49 are extended out of the power supplying coupler 46.

Projected portions 51 which elastically contact an inner surface of the recessed portion 45 are provided to project at a plurality of spots on an outer surface of the cylinder wall 39 in the power receiving coupler 40, and in this embodiment, three projected portions 51 which elastically contact the inner surface of the recessed potion 45 are projectingly provided at the outer surface of the cylinder wall 39, and these projected portions 51 are formed at the second resin molded layer 7b at the portion forming a part of the power receiving coupler 40.

A part of the side wall of the cylinder wall 39 is formed by a wall portion 39a in a flat plate shape, and a pair of guide walls 52 and 52 projected sideward from the cylinder wall 39 are integrally provided to connect to the wall portion 39a to continue to be flush with each other, and a pair of guide recessed portions 53 and 53 opened to the inner surface of the recessed portion 45 into which the cylinder wall 39 is inserted are provided at the power supplying coupler 46 to allow the guide walls 52 and 52 to be detachably fitted in the guide recessed portions 53 and 53, and these guide walls 52 are also formed at the first resin molded layer 7a.

An engaging projection 55 in which an engaging claw 54 provided at the power supplying coupler 46 is engaged to be able to engage and disengage is provided at an outer surface of a side wall at the side of the solenoid housing 25, of the side wall of the cylinder wall 39 to sandwich the engaging groove 41 between the engaging projection 55 and the projected portions 51, and the engaging projection 55 is formed at the first resin molded layer 7a at the portion forming a part of the power receiving coupler 40.

Next, explaining an operation of the first embodiment, the resin molded part 7 is formed by two-layer molding of the first resin molded layer 7a which covers at least part of the solenoid housing 25 and forming a coupler main part 40a forming the skeletal structure of the power receiving coupler 40, and the second resin molded layer 7b which is formed of the material with smaller bending strength than the first resin molded layer 7a and covers the first resin molded layer 7a so that the first resin molded layer 7a is exposed at the tip end side from the intermediate portion of the power receiving coupler 40.

Accordingly, the connection portions of the coil 30 of the coil assembly 24 and the power receiving side connecting terminals 38 are covered with the first resin molded layer 7a and the coupler main part 40a forming the skeletal structure of the power receiving coupler 40 is formed of the first resin molded layer 7a, whereby, the strength capable of securing reliability of the electrical connection portions can be given to the resin molded part 7. The second resin molded layer 7b covering the first resin molded layer 7a is formed of the synthetic resin relatively low in bending strength, whereby it is possible to suppress occurrence of the operation sound effectively, and as compared with the fuel injection valve of which entire body is covered with the noise-proof cover, the entire electromagnetic fuel injection valve can be made compact. In addition, the portion up to the intermediate portion of the power receiving coupler 40 is molded to be in two layers, whereby occurrence of the operation sound from the power receiving coupler 40 can be effectively reduced by the second resin molded layer 7b while the strength required of the power receiving coupler 40 is obtained with the first resin molded layer 7a.

In addition, the first resin molded layer 7a is formed of liquid crystal polymer in which the glass fibers are mixed, and the liquid crystal polymer in which the glass fibers are mixed has the function of relatively suppressing transmission of the operation sound, and has high rigidity. Therefore, the strength for securing reliability of the electrical connection portion can be more enhanced, and occurrence of operation sound can be suppressed more effectively.

The second resin molded layer 7b is formed of thermoplastic polyester elastomer with mixture of glass fibers excluded, and thermoplastic polyester elastomer with mixture of the glass fibers excluded has excellent elasticity, thus making it possible to effectively suppress occurrence of the operation sound.

At the intermediate portion of the power receiving coupler 40, the endlessly continuing engaging groove 41 in which the second resin molded layer 7b is engaged is formed in the first resin molded layer 7a. Therefore, shrinkage of the second resin molded layer 7b after completion of two-layer molding can be suppressed, and adhesion of the two layers is enhanced to make it possible to improve the production quality. Especially in this embodiment, the endless engaging groove 42 in which the second resin molded layer 7b is engaged is also formed in the first resin molded layer 7a at the portion corresponding to the rear portion of the valve housing 8, and therefore, the production quality can be more enhanced.

The power supplying coupler 46 having the recessed portion 45 in which the cylinder wall 39 is inserted is attachably and detachably connected to the power receiving coupler 40 having the cylinder wall 39 to which the power receiving side connecting terminals 38 are faced, and the power supplying side connecting terminals 49, which make electrical connection with the power receiving side connecting terminals 38 possible, are provided in the power supplying coupler 46, and the projected portions 51 which elastically contact the inner surface of the recessed portion 45 are provided at a plurality of spots on the outer surface of the cylinder wall 39.

Accordingly, the cylinder wall 39 does not vibrate in the recessed portion 45, and occurrence of the operation sound can be suppressed by suppressing the vibration of the power receiving coupler 40 and the power supplying coupler 46. A special member for suppressing occurrence of the operation sound is not required, and therefore, cost reduction can be realized by avoiding increase in the number of components.

In addition, the projected portions 51 are formed at the second resin molded layer 7b at the portion which forms a part of the power receiving coupler 40, and therefore, resistance against vibration can be more enhanced, thus making it possible to further reduce resonance.

A pair of guide walls 52 and 52 which project sideward from the cylinder wall 39 are integrally provided at the wall portion 39a in the flat plate shape forming a part of the side wall of the cylinder wall 39 to connect to the wall portion 39a to be flush with the wall portion 39a, and the power supplying coupler 46 is provided with a pair of guide recessed portions 53 and 53, which open to the inner surface of the recessed portion 45 in which the cylinder wall 39 is inserted, to enable the guide walls 52 and 52 to be detachably fitted into the guide recessed portions 53 and 53. Therefore, the shape for guiding the cylinder wall 39 in the recessed portion 45 is simplified, and the shapes of the molds for molding the power receiving coupler 40 and the power supplying coupler 46 are simplified, thus making it possible to contribute to reduction in manufacturing cost.

Since the engaging projection 55 with which the engaging claw 54 of the power supplying coupler 46 is engaged to be capable of being disengaged is projectingly provided on the outer surface of the side wall at the solenoid housing 25 side of the side wall of the cylinder wall 39, it is possible to suppress protrusion of the power supplying coupler 46 in the outward direction of the electromagnetic fuel injection valve, and this is especially effective for application to motor cycles and the like limited in the mounting space. A protection wall for protecting the engaging portion of the power supplying coupler 46 with the power receiving coupler 40 is not required, and the shape of the power supplying coupler 46 is more simplified, thus making it possible to reduce manufacturing cost more by simplification of the shape of the mold for molding the power supplying coupler 46.

The engaging projection 55 is formed at the first resin molded layer 7a at the portion forming a part of the power receiving coupler 40 to sandwich the engaging groove 41 provided at the intermediate portion of the power receiving coupler 40 between the engaging projection 55 and the projected portions 51, and therefore, by forming the engaging projection 55, with which the power supplying coupler 46 is engaged, at the first resin molded layer 7a with relatively high bending strength, sufficient durability against repetition of attachment and detachment of the power supplying coupler 46 can be secured.

### Embodiment 2

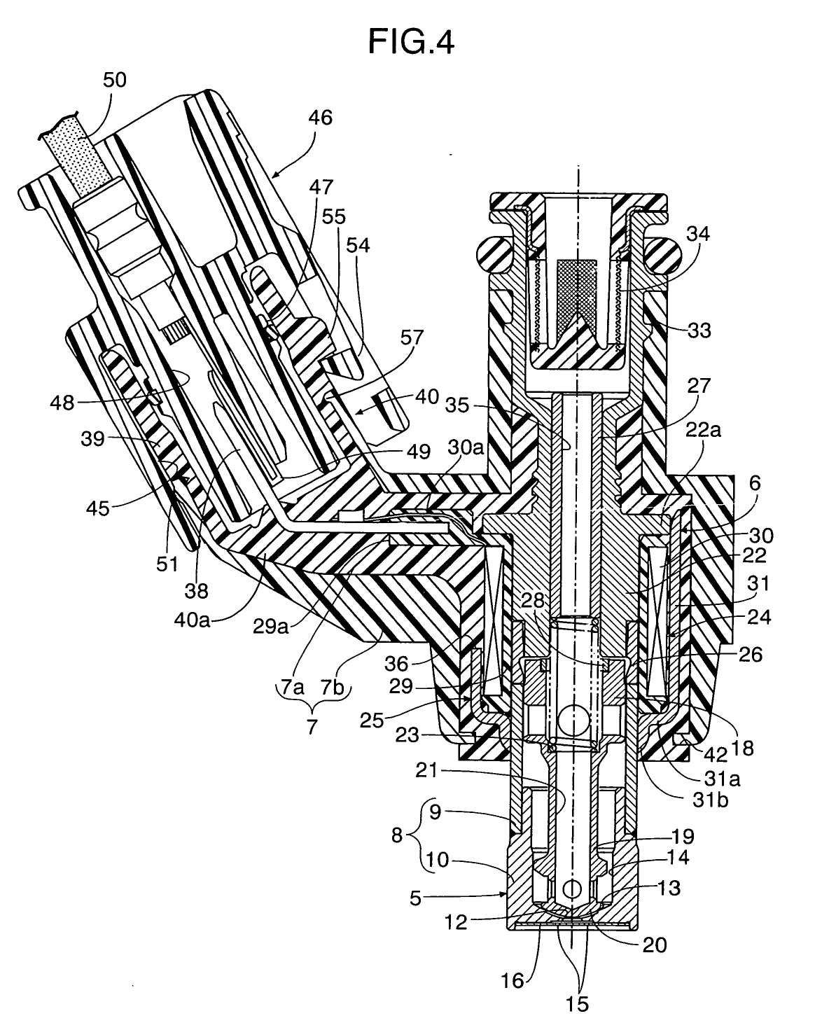

As a second embodiment of the present invention, an engaging groove 57 which endlessly continues with its cross sectional shape in a substantially V-shape may be provided at the first resin molded layer 7a at the intermediate portion of the power receiving coupler 40 so that the second resin molded layer 7b is engaged in the engaging groove 57 as shown in FIG. 4.

### Embodiment 3

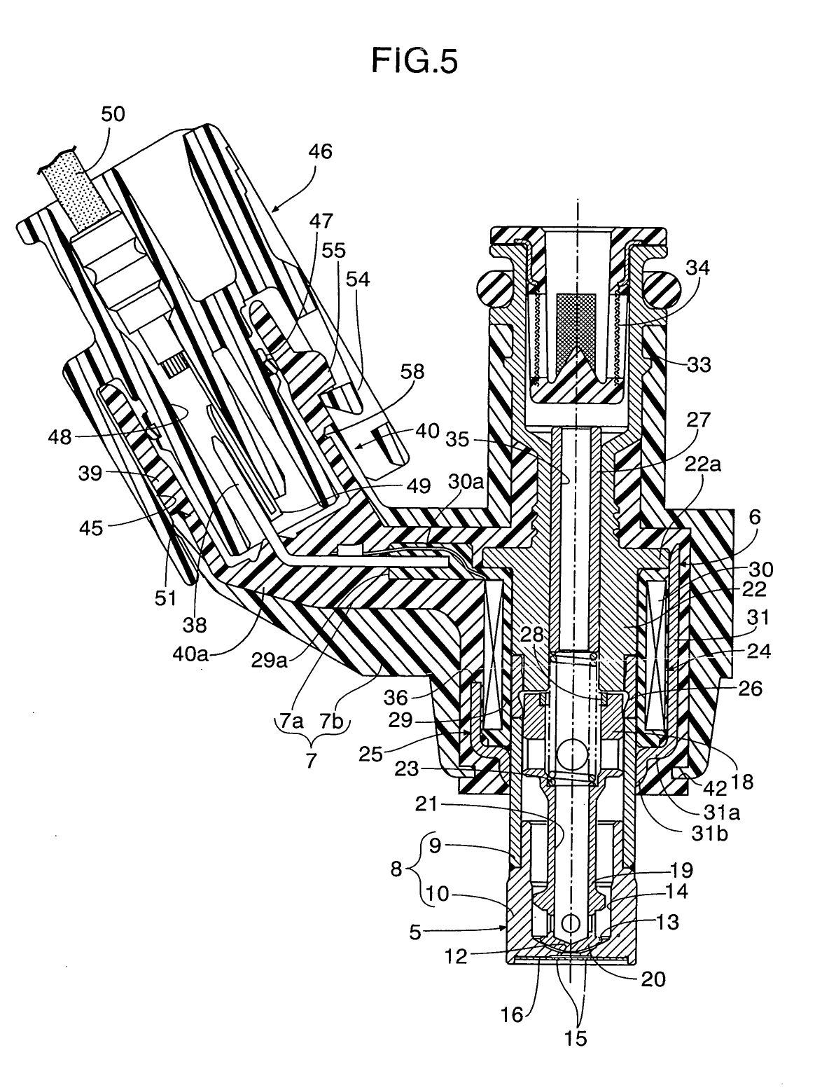

As a third embodiment of the present invention, an engaging groove 58 which endlessly continues may be provided at the first resin molded layer 7a at the intermediate portion of the power receiving coupler 40 so that the second resin molded layer 7b is engaged in the engaging groove 58 in a wedge shape, as shown in FIG. 5.

As other embodiments of the present invention, adhesion of the first and the second resin molded layers 7a and 7b may be enhanced by performing embossing work for the outer surface of the portion of the first resin molded layer 7a covered with the second resin molded layer 7b, or forming corrugated projections and recessions on the outer surface.

### Embodiment 4

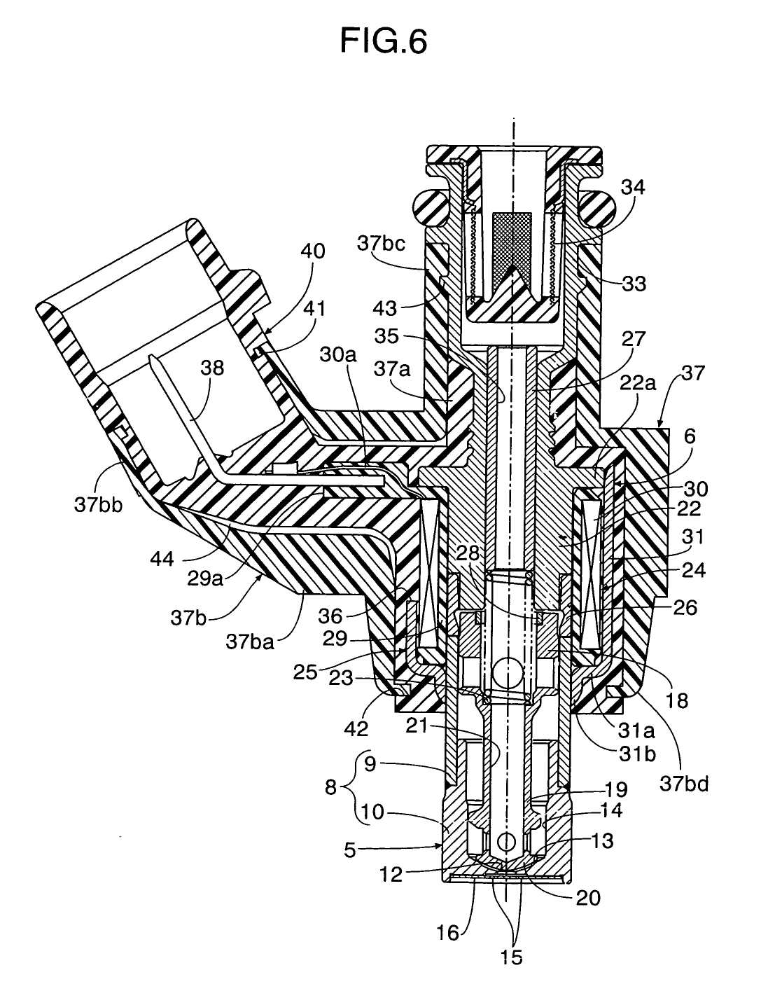

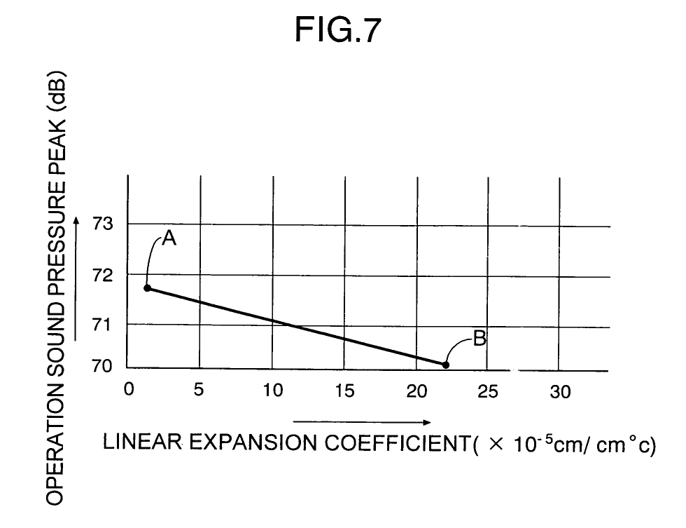

FIGS. 6 and 7 show a fourth embodiment of the present invention. The parts corresponding to the above-mentioned first to third embodiments are given the same reference numerals and symbols and only shown in the drawings, and the detailed explanation of them will be omitted.

First in FIG. 6, a resin molded part 37 of a synthetic resin, which integrally has the power receiving coupler 40 to which the power receiving side connecting terminals 38 connecting to the coil 30 of the coil assembly 24 are faced and in which at least coil assembly 24 and the solenoid housing 25 are embedded, is formed to bury and seal not only the solenoid housing 25 and the coil assembly 24, but also a part of the valve housing 8 and most part of the inlet cylinder 33 while filling a gap between the solenoid housing 25 and the coil assembly 24. The magnetic frame 31 of the solenoid housing 25 is provided with the notched portion 36 for allowing the arm portion 29a integrally formed at the bobbin 29 of the coil assembly 24 to be disposed outside the solenoid housing 25.

The resin molded part 37 is integrally provided with the power receiving coupler 40 to which the power receiving side connecting terminals 38 connecting to opposite ends of the coil 30 in the coil assembly 24 are faced, the base end of the power receiving side connecting terminal 38 is embedded in the arm portion 29a, and the coil ends 30a of the coil 30 is welded to the power receiving side connecting terminals 38.

Incidentally, the resin molded part 37 is formed by a first resin molded layer 37a which covers at least a part of the solenoid housing 25 and forms apart of the power receiving coupler 40, and a second resin molded layer 37b which covers the first rein molded layer 37a. In this fourth embodiment, all parts of the solenoid housing 25, the rear part of the valve housing 8 and a part of the inlet cylinder 33 are covered with the first resin molded layer 37a, and a part of the power receiving coupler 40 is formed of the first resin molded layer 37a.

While the first resin molded layer 37a is formed of a material with relatively large bending strength, for example, liquid crystal polymer with glass fibers mixed therein, the second resin molded layer 37b is formed of a material with smaller bending strength than the first resin molded layer 37a, for example, thermoplastic polyester elastomer with mixture of glass fibers excluded, for example, Hytrel, Tradename (E. I DuPont de Nemours & Company (Inc.) U.S.A.).

The relationship of the bending strength and the operation sound pressure peak occurring from the resin molded part 37 in the case where the entire resin molded part 37 is formed of liquid polymer including, for example, 35% of glass fibers is as shown by the point A in FIG. 7, and the liquid crystal polymer has the function of relatively suppressing the transmission of the operation sound and has high rigidity. On the other hand, when the entire resin molded part 37 is formed of thermoplastic polyester elastomer with exclusion of mixture of glass fibers, occurrence of the operation sound can be suppressed by excellent flexibility of thermoplastic polyester elastomer, and as shown by the point B in FIG. 7, the operation sound pressure peak can be suppressed to be low though the bending strength becomes lower as compared with liquid crystal polymer.

The second resin molded layer 37b is formed by a thick-walled portion 37ba at its center part, and thin-walled portions 37bb, 37bc and 37bd at tail end sides connecting to the thick-walled portion, as the thinner portions than the thick-walled portion 37ba, and the thin-walled portions 37bb to 37bd are engaged in the first resin molded layer 37a or the inlet cylinder 33 as a metal member in the form of projections and recessions.

Namely, at the tip end side from the intermediate portion of the power receiving coupler 40, the first resin molded layer 37a is exposed to the outside without being covered with the second resin molded layer 37b, the rear part of the inlet cylinder 33 is exposed to the outside without being covered with the second resin molded layer 37b, and a part of the first rein molded layer 37a at the portion corresponding to the rear part of the valve housing 8 is exposed to the outside without being covered with the second resin molded layer 37b. Thus, endless engaging grooves 41 and 42 in which the end portions of the thin-walled portions 37bb and 37bd of the second resin molded layer 37b are formed at the first resin molded layer 37a at the portions corresponding to the intermediate portion of the power receiving coupler 40 and the rear portion of the valve housing 8, and an engaging projected portion 43 which engages in the inner surface of the thin-walled portion 37bc in the second resin molded layer 37b is projectingly provided at the outer periphery of the intermediate portion of the inlet cylinder 33. In addition, in the vicinity of the projection-and-recession engaging portion with the thin-walled portions 37bb and 37bd, the outer surface of the first resin molded layer 37a is formed to have a rougher surface than the other portions by formation of an embossed pattern, molding of corrugated projections and recessions and the like.

Next, explaining an operation of the fourth embodiment, the resin molded part 37 is formed by two-layer molding of the first resin molded layer 37a which covers at least a part of the solenoid housing 25 and forms a part of the power receiving coupler 40, and the second resin molded layer 37b which is formed of the material with larger linear expansion coefficient than the first resin molded layer 37a and covers the first resin molded layer 37a.

Accordingly, the connecting portions of the coil 30 of the coil assembly 24 and the power receiving side connecting terminals 38 are covered with the first resin molded layer 37a and the main part of the power receiving coupler 40 is formed of the first resin molded layer 37a, whereby, the strength capable of securing reliability of the electrical connecting portion can be given to the resin molded part 37. The second resin molded layer 37b covering the first resin molded layer 37a is formed of the synthetic resin with relatively large linear expansion coefficient, whereby it is possible to suppress occurrence of the operating sound effectively, and since an air layer 44 is partially formed between the first and the second resin molded layers 37a and 37b, transmission of the operation sound can be further suppressed. As compared with the fuel injection valve of which entire body is covered with the noise-proof cover, the entire electromagnetic fuel injection valve can be made compact.

In addition, the first resin molded layer 37a is formed of liquid crystal polymer in which the glass fibers are mixed, and the liquid crystal polymer in which the glass fibers are mixed has the function of relatively suppressing transmission of the operation sound, and has high rigidity. Therefore, the strength for securing reliability of the electrical connection portion can be more enhanced, and occurrence of operation sound can be suppressed more effectively.

The second resin molded layer 37b is formed of thermoplastic polyester elastomer with mixture of glass fibers excluded, and thermoplastic polyester elastomer with mixture of the glass fibers excluded has excellent elasticity, thus making it possible to effectively suppress occurrence of the operation sound.

The second resin molded layer 37b is formed by the thick-walled portion 37ba at its center part, and the thin-walled portions 37bb, 37bc and 37bd at the tail end sides connecting to the thick-walled portion 37ba as the thinner portions than the thick-walled portion 37ba, and the thin-walled portions 37bb and 37bd are engaged in the first resin molded layer 37a at the portions corresponding to the intermediate portion of the power receiving coupler 40 and the rear portion of the valve housing 8 in the form of projections and recessions, and the thin-walled portion 37bc is engaged in the intermediate portion of the inlet cylinder 33 integrated with the fixed core 22 in the form of projections and recessions. Therefore, by changing the wall thickness of the second resin molded layer 37b in accordance with regions, a shrinkage amount at the time of cooling directly after molding is partially changed, and the air layer 44 can be automatically formed at the peripheral part of the thick-walled portion 37ba.

Namely, in the thin-walled portions 37bb to 37bd at the tail end side, cooling speed is relatively high, and the shrinkage amount can be suppressed to be small since adhesion to the first resin molded layer 37 or the inlet cylinder 33 is enhanced by the projection-and-recession engagement, and in the thick-walled portion 37ba at the center part, cooling speed is relatively slow, and the shrinkage amount becomes relatively large. Therefore, the center part of the second resin molded layer 37b is gradually cooled to be shrunk to a relatively large extent while shrinking the second resin molded layer 37b at the tail end side by the projection-and-recession engagement, and thereby, it is made possible to form the air layer 44 in the peripheral part of the thick-walled portion 37ba.

Since the outer surface of the first resin molded layer 37a is formed to be a rougher surface than the other parts, in the vicinity of the projection-and-recession engagement with the thin-walled portions 37bc and 37bd, adhesion of the second resin molded layer 37b at the tail end side to the first resin molded layer 37a can be enhanced, and shrinkage of the second resin molded layer 37b after two-layer molding is suppressed to make it possible to improve quality.

The embodiments of the present invention are explained thus far, but the present invention is not limited to the above mentioned embodiments, and various design change can be made without departing from the present invention described in claims.

1. An electromagnetic fuel injection valve, comprising:
a valve operating part (5) in which a valve body (20) spring-biased in a direction to be seated in a valve seat (13) is accommodated in a valve housing (8) having the valve seat (13) at a front end thereof;
a solenoid part (6) in which a coil assembly (24) capable of exhibiting electromagnetic force for driving the valve body (20) to a side to separate from the valve seat (13) is accommodated in a solenoid housing (25) provided to connect to the valve housing (8); and
a resin molded part (7) of a synthetic resin which integrally has a power receiving coupler (40) to which a power receiving side connecting terminal (38) connecting to a coil (30) of the coil assembly (24) is faced, at least part of the solenoid housing (25) being embedded in the resin molded part (7),
characterized in that the resin molded part (7) comprises a first resin molded layer (7a) which is formed of a synthetic resin with mixture of glass fibers to cover at least part of the solenoid housing (25) and form at least part of the coupler (40), and a second resin molded layer (7b) which is formed of thermoplastic polyester elastomer with mixture of glass fibers excluded to cover the first resin molded layer (7a).

2. The electromagnetic fuel injection valve according to claim 1, wherein the first resin molded layer (7a) is formed of liquid crystal polymer with mixture of glass fibers.

3. An electromagnetic fuel injection valve, comprising:
a valve operating part (5) in which a valve body (20) spring-biased in a direction to be seated in a valve seat (13) is accommodated in a valve housing (8) having the valve seat (13) at a front end thereof;
a solenoid part (6) in which a coil assembly (24) capable of exhibiting electromagnetic force for driving the valve body (20) to a side to separate from the valve seat (13) is accommodated in a solenoid housing (25) provided to connect to the valve housing (8); and
a resin molded part (7) of a synthetic resin which integrally has a power receiving coupler (40) to which a power receiving side connecting terminal (38) connecting to a coil (30) of the coil assembly (24) is faced, at least part of the solenoid housing (25) being embedded in the resin molded part (7),
characterized in that the resin molded part (7) is formed by two-layer molding of a first resin molded layer (7a) which covers at least part of the solenoid housing (25) and forms a coupler main part (40a) forming a skeletal structure of the power receiving coupler (40), and a second resin molded layer (7b) which is formed of a material with smaller bending strength than the first resin molded layer (7a) and covers the first resin molded layer (7a) so that the first resin molded layer (7a) is exposed at a tip end side from an intermediate portion of the power receiving coupler (40), and at least one engaging groove (41, 57, 58) endlessly continuing in which the second resin molded layer (7b) is engaged is formed at the first resin molded layer (7a) at the intermediate portion of the power receiving coupler (40).

4. The electromagnetic fuel injection valve according to claim 3, wherein a projected portion (51) which elastically contacts a power supplying coupler (46) attachably and detachably connected to the power receiving coupler (40) is formed at the second resin molded layer (7b) at the portion forming part of the power receiving coupler (40), and an engaging projection (55) which detachably engages with the power supplying coupler (46) is formed at the first resin molded layer (7a) at the portion forming part of the power receiving coupler (40) to sandwich the engaging groove (41, 57, 58) between the engaging projection (55) and the projected portion (51).

5. The electromagnetic fuel injection valve according to claim 3 or 4, wherein the first resin molded layer (7a) is formed of liquid crystal polymer with mixture of glass fibers.

6. The electromagnetic fuel injection valve according to claim 3 or 4, wherein the second resin molded layer (7b) is formed of thermoplastic polyester elastomer with mixture of glass fibers excluded.

7. An electromagnetic fuel injection valve, comprising:
a valve operating part (5) in which a valve body (20) spring-biased in a direction to be seated in a valve seat (13) is accommodated in a valve housing (8) having the valve seat (13) at a front end thereof;
a solenoid part (6) in which a coil assembly (24) capable of exhibiting electromagnetic force for driving the valve body (20) to a side to separate from the valve seat (13) is accommodated in a solenoid housing (25) provided to connect to the valve housing (8); and
a resin molded part (37) of a synthetic resin which integrally has a power receiving coupler (40) to which a power receiving side connecting terminal (38) connecting to a coil (30) of the coil assembly (24) is faced, at least part of the solenoid housing (25) being embedded in the resin molded part (37),
characterized in that the resin molded part (37) is formed by two-layer molding of a first resin molded layer (37a) which covers at least part of the solenoid housing (25) and forms part of the power receiving coupler (40), and a second resin molded layer (37b) which is formed of a material with larger linear expansion coefficient than the first resin molded layer (37a) and covers the first resin molded layer (37a), and an air layer (44) is partially formed between the first and the second resin molded layers (37a, 37b).

8. The electromagnetic fuel injection valve according to claim 7, wherein the second resin molded layer (37b) comprises a thick-walled portion (37ba) at the center part thereof, and a thin-walled portion (37bb, 37bc, 37bd) at a tail end side which connects to the thick-walled portion (37ba) as a thinner portion than the thick-walled portion (37ba), and the thin-walled portion (37bb to 37bd) interlocks with the first resin molded layer (37a) or a metal member (33) via concavo-convex engagement.

9. The electromagnetic fuel injection valve according to claim 8, wherein an outer surface of the first resin molded layer (37a) is formed to be a rougher surface than the other parts, in a vicinity of concavo-convex engagement portions with the thin-walled portions (37bb, 37bd).

10. The electromagnetic fuel injection valve according to any one of claims 7 to 9, wherein the first resin molded layer (37a) is formed of liquid crystal polymer with mixture of glass fibers.

11. The electromagnetic fuel injection valve according to any one of claims 7 to 9, wherein the second resin molded layer (37b) is formed of thermoplastic polyester elastomer with mixture of glass fibers excluded.
